(19) United States
(12) Patent Application Publication
(10) Pub. No.: US 2011/0096301 A1
(43) Pub. Date: Apr. 28, 2011

(54) IMAGE PROJECTION APPARATUS WITH SHUTTER UNIT

(75) Inventor: Takehiro Koyama, Utsunomiya-shi (JP)

(73) Assignee: CANON KABUSHIKI KAISHA, Tokyo (JP)

(21) Appl. No.: 12/904,752

(22) Filed: Oct. 14, 2010

(30) Foreign Application Priority Data
Oct. 28, 2009 (JP) 2009-247236

(51) Int. Cl. G03B 21/14

(52) U.S. Cl. 353/88

(57) ABSTRACT

The image projection apparatus includes a light modulating element, a projection lens configured to project light modulated by the light modulating element onto a projection surface, an optical unit configured to introduce light from a light source to the light modulating element, and to introduce the light from the light modulating element to the projection lens, a shutter unit disposed between the optical unit and the projection lens, and configured to be capable of shutting to block the light from the optical unit from entering the projection lens. A controller is configured to set an operation state of the light modulating element such that, in a state where the shutter unit is shut, an intensity of the light reaching the shutter unit from the optical unit becomes smaller than that in an entire white display state.

### BACKGROUND OF THE INVENTION

1. Field of the Invention

The present invention relates to an image projection apparatus such as a projector, which is provided with a shutter unit for obtaining a non-image display state.

2. Description of the Related Art

In projectors used for meetings or the like, an image display (image projection) state and a non-image display (non-image projection) state are often repeatedly switched at short time intervals. Although the projectors generally use a high-intensity discharge lamp as a light source illuminating a light modulating element such as a liquid crystal panel, a lifetime of the high-intensity discharge lamp is reduced by repetition of turning on and off. Furthermore, the high-intensity discharge lamp requires a certain time period for stabilization of brightness and color after the turning on thereof, and also requires a certain cooling-down time period from the turning off to re-turning on.

It is possible to produce a pseudo non-image display state by causing the light modulating element to operate so that a black image is projected with the light source being turned on. However, since an illuminance of the black image is increased as an intensity of the projector is increased, the projected black image provides glare to an observer.

Therefore, it is desirable to open and shut a shutter unit capable of blocking light from the turned-on light source so as to switch the image display state and the non-image display state. Japanese Patent No. 4128155 discloses a projector in which a shutter unit is disposed between a light source and an illumination optical system disposed subsequently thereto (that is, closer to the light source than a light modulating element). Moreover, Japanese Patent Laid-Open No. 2008-102376 discloses a projector in which a shutter unit is provided in front of a projection lens (that is, closer to a projection surface than the projection lens).

However, in the projector disclosed in Japanese Patent No. 4128155, opening and shutting of the shutter unit disposed between the light source and the illumination optical system greatly varies an intensity of the light entering the light modulating element. Thus, temperature of the light modulating element changes rapidly, and thereby a thermal stress generated in the light modulating element rapidly increases and decreases, which affects operations and a lifetime of the light modulating element.

Furthermore, in the projector disclosed in Japanese Patent Laid-Open No. 2008-102376, provision of the shutter unit in front of the projection lens that generally has a larger lens diameter as a position becomes closer to the projection surface (that is, becomes further on a magnifying side) increases a size of the shutter unit itself, which increases a size of the entire projector. In addition, since the light from the light source enters the projection lens even when the shutter unit is shut, temperature of the projection lens rises, which causes variation of focus due to change of refractive indexes of lens units constituting the projection lens and distances therebetween.

### SUMMARY OF THE INVENTION

The present invention provides an image projection apparatus capable of reducing influences on the operations and the lifetime of the light modulating element, and capable of suppressing the increase in size of the apparatus and the variation of focus.

The present invention provides as one aspect thereof an image projection apparatus including a light modulating element, a projection lens configured to project light modulated by the light modulating element onto a projection surface, an optical unit configured to introduce light from a light source to the light modulating element, and to introduce the light from the light modulating element to the projection lens, a shutter unit disposed between the optical unit and the projection lens, and configured to be capable of shutting to block the light from the optical unit from entering the projection lens, and a controller configured to set an operation state of the light modulating element such that, in a state where the shutter unit is shut, an intensity of the light reaching the shutter unit from the optical unit becomes smaller than that in an entire white display state.

Further features of the present invention will become apparent from the following description of exemplary embodiments with reference to the attached drawings.

### BRIEF DESCRIPTION OF THE DRAWINGS

FIG. 1 is a perspective view of a projector that is Embodiment 1 of the present invention.

FIG. 2 is a side view showing an optical configuration of the projector of Embodiment 1.

FIGS. 3A and 3B are side views showing part around a shutter unit in the projector of Embodiment 1.

FIG. 4 is a front view showing a configuration of the shutter unit.

FIGS. 5A and 5B are front views showing movements of the shutter unit.

FIGS. 6A and 6B are perspective views of a projector that is Embodiment 2 of the present invention.

FIG. 7 is a flowchart showing operations of the projector of Embodiment 2.

FIG. 8 is a side view showing an optical configuration of a projector that is Embodiment 3 of the present invention.

FIG. 9 is a flowchart showing operations of the projector of Embodiment 3.

### DESCRIPTION OF THE PREFERRED EMBODIMENTS

Exemplary embodiments of the present invention will hereinafter be described with reference to the accompanying drawings.

### Embodiment 1

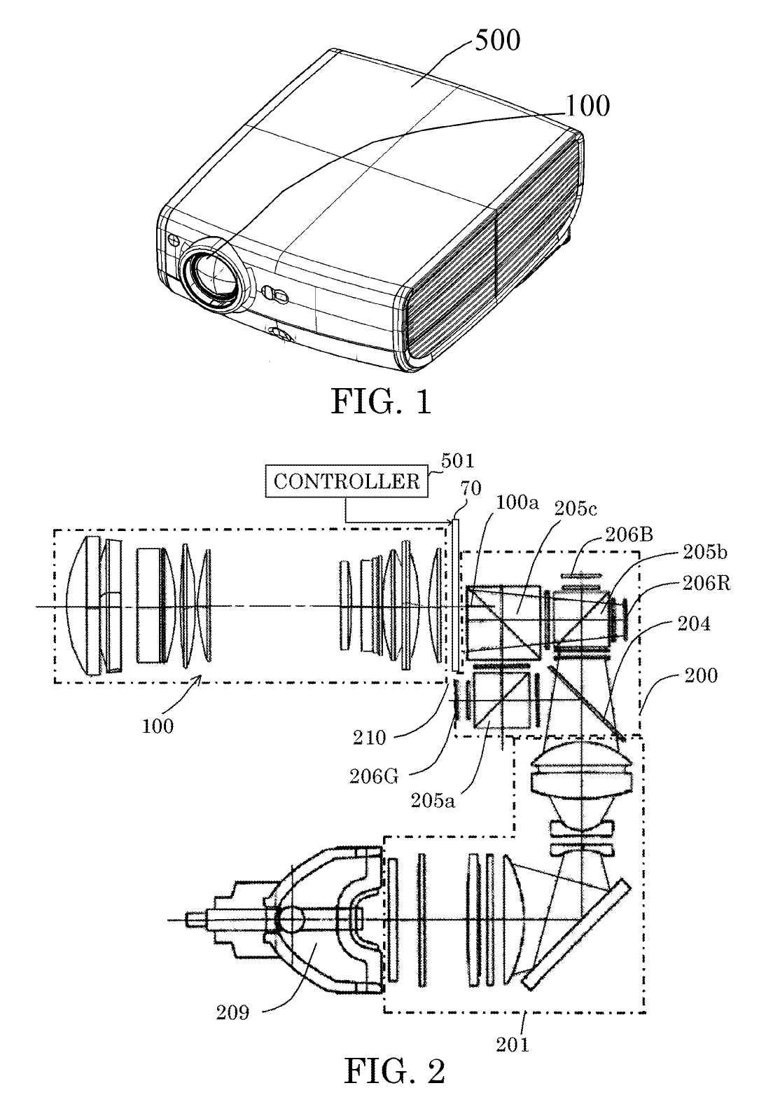

FIG. 1 shows an external appearance of a projector 500 as an image projection apparatus which is a first embodiment (Embodiment 1) of the present invention. Reference numeral 100 denotes a projection lens.

FIG. 2 shows a configuration of an optical system housed in a chassis (main body) of the projector 500. The chassis of the projector 500 houses an optical box that contains a light source lamp 209, a color separation/combination optical unit 200, an illumination optical system 201 and liquid crystal panels 206R, 206G and 206B which are light modulating elements. The chassis also houses the projection lens 100 and a shutter unit 70.

The projection lens 100 including plural lens units (optical elements) and holding members that hold the lens units is attached to a light exit opening portion formed in the optical box. The shutter unit 70 is disposed in the optical box between the color separation/combination optical unit 200 and the projection lens 100.

The liquid crystal panels 206R, 206G and 206B are connected to a liquid crystal driving circuit (not shown). The liquid crystal driving circuit causes the liquid crystal panels 206R, 206G and 206B to form original images according to image information input to the projector 500 from an image supply apparatus (not shown) such as a personal computer, a DVD player or a television tuner. The liquid crystal panels 206R, 206G and 206B modulate light entering thereto. The light modulated by the liquid crystal panels 206R, 206G and 206B is projected onto a projection surface such as a screen through the projection lens 100. The liquid crystal panels 206R, 206G and 206B in this embodiment are reflective liquid crystal panels.

The illumination optical system 201 introduces light from the light source lamp 209 to the color separation/combination optical unit 200. The color separation/combination optical unit 200 separates the light from the illumination optical system 201 into three color light components, and introduces them to the liquid crystal panels 206R, 206G and 206B, respectively. Further, the color separation/combination optical unit 200 combines the three color light components (modulated light components) and introduces the combined light components (combined light) to the projection lens 100.

The shutter unit 70 operates between an opened state and a shut (closed) state to open and shut (or close or block) an optical path of the light proceeding from the color separation/combination optical unit 200 toward the projection lens 100. The shutter unit 70 is not an aperture stop (not shown) provided in the projection lens 100. The aperture stop does not completely shut its aperture even when the aperture is smallest, and just adjusts an intensity (amount) of the light from the light source lamp 209 projected onto the projection surface. On the other hand, the shutter unit 70 completely shuts its aperture in the shut state so as to prevent the light from the light source lamp 209 from being projected onto the projection surface.

The illumination optical system 201 includes a light dividing and condensing system that is constituted by two fly-eye lenses and a condenser lens, and divides the light from the light source lamp 209 into plural light fluxes and then overlaps the plural light fluxes on each liquid crystal panel. The light source lamp 209 in this embodiment is a high-intensity discharge lamp such as an extra-high pressure mercury lamp. Moreover, the illumination optical system 201 includes a polarization conversion element that converts the light from the light source lamp 209 into polarized light (P-polarized light in this embodiment) having a predetermined polarization direction.

The color separation/combination optical unit 200 includes a dichroic mirror 204, first to third polarization beam splitters 205a to 205c and holding members (not shown) that hold these optical elements. The dichroic mirror 204 transmits, of white light from the illumination optical system 201 (that is, from the light source lamp 209), a light component of blue (B) and a light component of red (R), and reflects a light component of green (G). The light components of blue, red and green are hereinafter respectively referred to as “B-light”, “R-light” and “G-light”. The first and second polarization beam splitters 205a and 205b transmit P-polarized light and reflect S-polarized light. The third polarization beam splitter 205c is a color combining prism serving as a dichroic prism reflecting the G-light and transmitting the B-light and as a polarization beam splitter for the R-light transmitting P-polarized light and reflecting S-polarized light.

The G-light as P-polarized light reflected by the dichroic mirror 204 and then transmitted through the first polarization beam splitter 205a enters the liquid crystal panel 206G for green and is reflected and modulated thereby to be converted into S-polarized light. Then, the G-light is reflected by the first polarization beam splitter 205a and thereafter enters the third polarization beam splitter 205c.

The R-light transmitted through the dichroic mirror 204 is subjected to rotation of its polarization direction by 90 degrees by a color selective phase plate to be converted into S-polarized light, and then enters the second polarization beam splitter 205b. The R-light reflected by the second polarization beam splitter 205b enters the liquid crystal panel 206R for red and is reflected and modulated thereby to be converted into P-polarized light. Then, the R-light is transmitted through the second polarization beam splitter 205b and thereafter enters the third polarization beam splitter 205c.

The B-light transmitted through the dichroic mirror 204 is transmitted through the color selective phase plate without being subjected to rotation of its polarization direction, and then enters the second polarization beam splitter 205b as P-polarized light. The B-light transmitted through the second polarization beam splitter 205b enters the liquid crystal panel 206B for blue and is reflected and modulated thereby to be converted into S-polarized light. Then, the B-light is reflected by the second polarization beam splitter 205b, and thereafter enters the third polarization beam splitter 205c.

The third polarization beam splitter 205c transmits the B-light and reflects the G-light as described above and further transmits the R-light as the P-polarized light, thereby combining these B-light, G-light and R-light to introduce the combined light to the projection lens 100. An R-image formed by the B-light, a G-image formed by the G-light and a B-image formed by the B-light are overlapped and projected onto the projection surface, thereby a full-color image is displayed thereon.

An optical axis (projection optical axis) 100a of the projection lens 100 is shifted in an upper direction with respect to an exit optical axis 210 of the third polarization beam splitter 205c, that is, of the color separation/combination optical unit 200. The “upper direction” means an upper direction when the projector 500 is placed on a table or the like. The shift of the projection optical axis 100a prevents a lower part of the light projected through the projection lens 100 onto the projection surface from being blocked by the table.

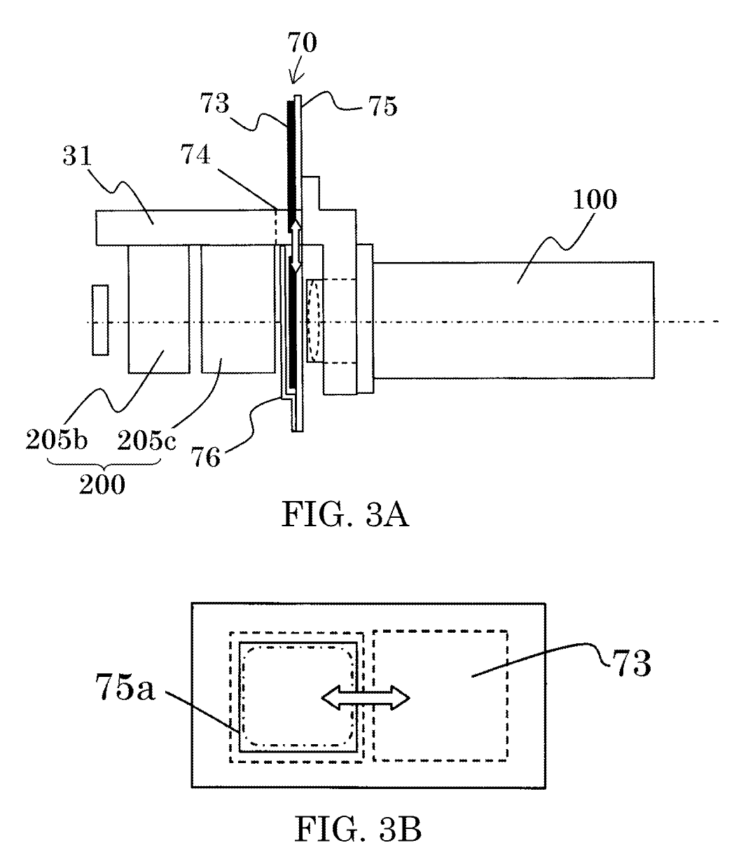

Next, description will be made of a configuration of the shutter unit 70 with reference to FIGS. 3A, 3B, 4, 5A and 5B. In these figures, reference numeral 31 denotes a prism base that holds the color separation/combination optical unit 200. A mount portion (flange portion) of the projection lens 100 is connected to this prism base 31. In addition, a shutter base plate 75 of the shutter unit 70 is attached to the prism base 31, the shutter unit 70 being disposed between a light exit surface of the color separation/combination optical unit 200 and a light entrance surface of the projection lens 100. A cover plate 76 is attached on a color separation/combination optical unit side surface of the shutter base plate 75. The shutter base plate 75 and the cover plate 76 have an aperture 75a through which the light proceeding from the color separation/combination optical unit 200 (that is, the light combined by the color separation/combination optical unit 200) toward the projection lens 100.

Reference numeral 73 denotes a shutter plate that is held between the shutter base plate 75 and the cover plate 76 so as to be movable in a direction opening and shutting the aperture 75a. When the shutter plate 73 is located at a position opening the aperture 75a (that is, the shutter unit 70 is in the opened state), the light from the color separation/combination optical unit 200 passes through the aperture 75a to enter the projection lens 100, and thus the light (that is, the full-color image) is projected from the projection lens 100 onto the projection surface. When the shutter plate 73 is located at a position shutting the aperture 75a (that is, the shutter unit 70 is in the shut state), the light from the color separation/combination optical unit 200 is blocked so as to be prevented from entering the projection lens 100, and thus no light is projected from the projection lens 100 onto the projection surface.

The shutter plate 73 is pressed by a blade spring from a cover plate side to a shutter base plate side, and thereby is positioned in a direction of the optical axis. The prism base 31 has a passage 74 through which the shutter plate 73 moving in its opening and shutting direction can pass.

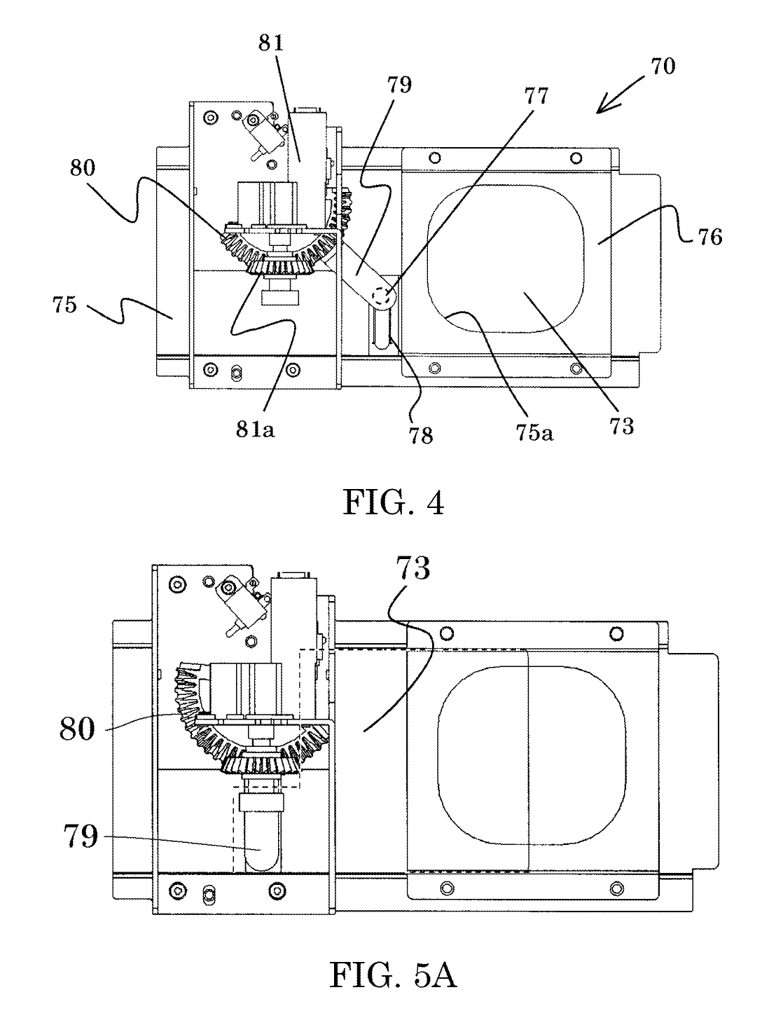

In FIG. 4, reference numeral 81 denotes a motor, and reference numeral 81a denotes a bevel gear that is fixed to an output shaft of the motor 81. Reference numeral 80 denotes a lever gear that engages with the bevel gear 81a and rotates in a plane along the shutter base plate 75. The lever gear 80 has a lever portion 79. A pin portion 77 is formed at a tip of the lever portion 79 and engages with an elongate hole portion 78 formed in the shutter plate 73.

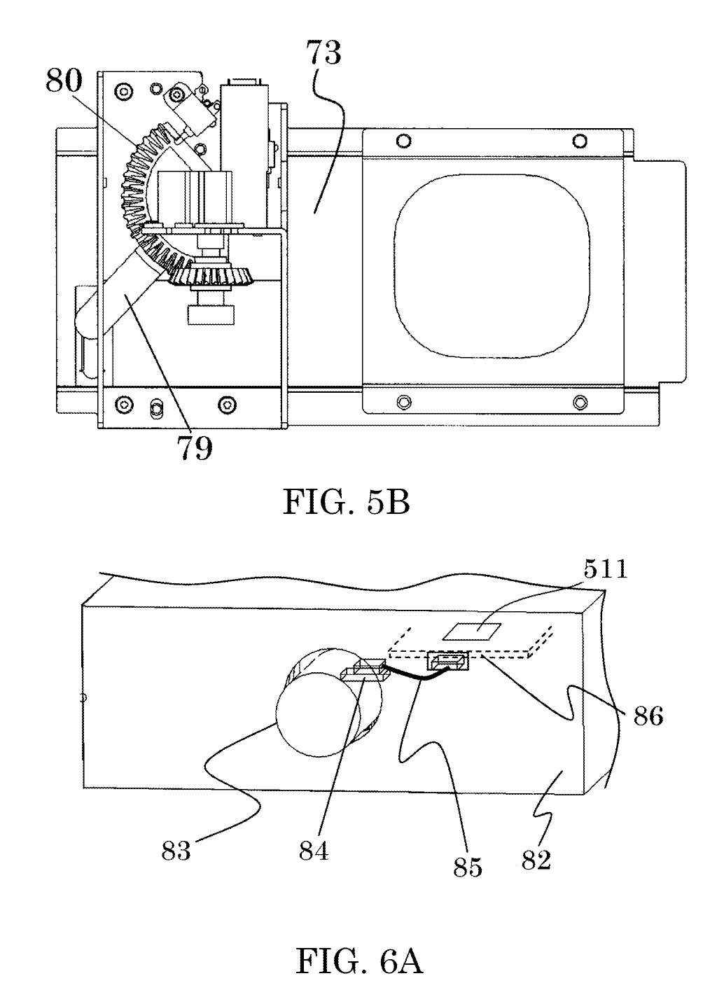

As shown in FIGS. 5A and 5B, rotation of the lever gear 80 with rotation of the motor 81 moves the pin portion 77 formed on the lever portion 79 inside the elongate hole portion 78, which moves the shutter plate 73 in the opening and shutting direction. A controller 501 shown in FIG. 2 drives the motor 81 in response to user's ON/OFF operations of a light-blocking switch (not shown), thereby moving the shutter plate 73 in the opening and shutting direction.

Thus, this embodiment enables the opening and shutting of the shutter unit 70 disposed between the color separation/combination optical unit 200 and the projection lens 100 to allow switching between an image display (image projection) state and a non-image display (non-image projection) state. Further, this embodiment introduces the light from the light source lamp 209 to the liquid crystal panels 206R, 206G and 206B through the color separation/combination optical unit 200 even when the shutter unit 70 is in the shut state. Therefore, between when the shutter unit 70 is in the opened state and when it is in the shut state, an intensity of the light reaching each of the liquid crystal panels 206R, 206G and 206B does not change greatly. Thus, temperature and a thermal stress of each of the liquid crystal panels 206R, 206G and 206B does not rapidly change with the opening and shutting of the shutter unit 70, which prevents influences on operations and a lifetime of each liquid crystal panel.

Moreover, when the shutter unit 70 is in the shut state, the light from the light source lamp 209 does not enter the projection lens 100. Therefore, temperature rise of the projection lens 100 in the shut state of the shutter unit 70 is not caused, and variation of focus due to the temperature rise is not caused either.

In addition, a light entrance side lens diameter of the projection lens 100 is smaller than a light exit side (magnifying side) lens diameter thereof. Thus, disposing the shutter unit 70 between the color separation/combination optical unit 200 and the projection lens 100 makes it possible to minimize the shutter unit 70 as compared with a case of disposing the shutter unit 70 closer to the projection surface than the projection lens 100. This contributes to miniaturization of the entire projector 500 equipped with the shutter unit 70.

It is desirable that the shutter plate 73 be formed of a metal material such as aluminum plate which can immediately radiate heat generated by the light reaching the shutter plate 73 in the shut state.

Furthermore, it is desirable to set an operation state of each of the liquid crystal panels 206R, 206G and 206B such that, in the shut state of the shutter unit 70 (that is, in the state where the shutter plate 73 is shut), an intensity of the light reaching the shutter plate 73 becomes smaller than that in an entire white display state where an entire white image is displayed. Specifically, it is desirable to set the operation state of each of the liquid crystal panels 206R, 206G and 206B to an entire black display state where an entire black image is displayed or an entire gray display state where an entire gray image is displayed. Such a setting enables reduction of the intensity of the light reaching the shutter plate 73 without greatly changing the intensity of the light entering each of the liquid crystal panels 206R, 206G and 206B, which makes it possible to suppress the temperature rise of the shutter plate 73.

### Embodiment 2

Embodiment 1 described the case where the shutter unit 70 opens and shuts in response to the user's operation of the light-blocking switch. However, a shutter unit equipped in a projector whose projection lens is interchangeable may automatically shut when the projector enters into a state where the projection lens is allowed to be interchanged. In the description below, components common to those in Embodiment 1 are denoted by the same reference numerals as those in Embodiment 1.

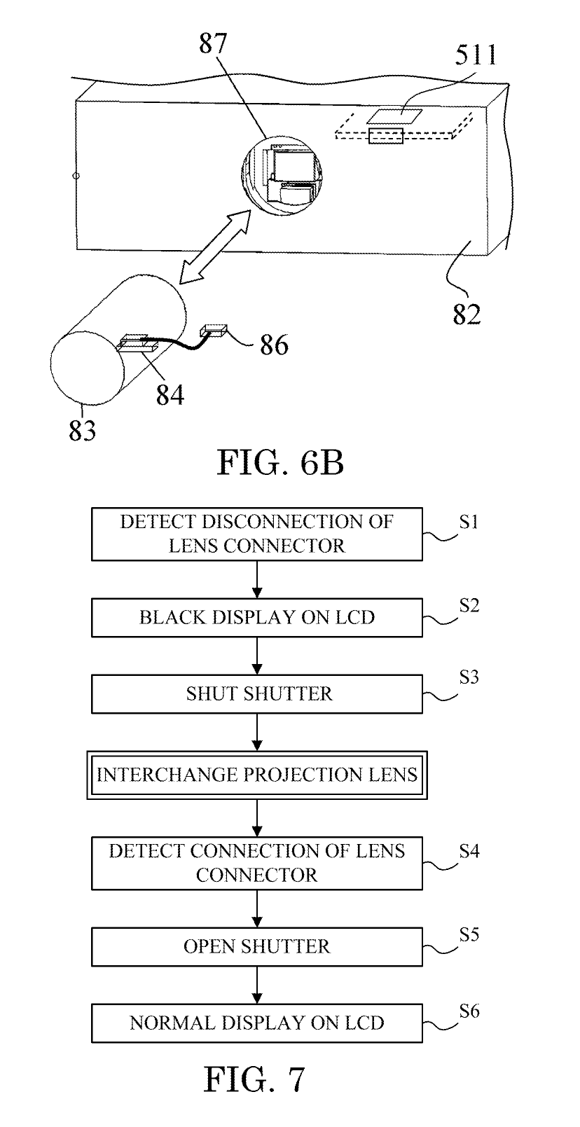

FIGS. 6A and 6B show a projector equipped with an interchangeable projection lens 83, the projector being a second embodiment (Embodiment 2) of the present invention. The projection lens 83 is provided with a lens circuit board 84. The lens circuit board 84 is provided with a memory storing various data to be communicated with a main circuit board 86 provided in a main body 82 of the projector. The lens circuit board 84 and the main circuit board 86 are connected to each other through a wiring harness 85 and communicate with each other therethrough. The wiring harness 85 is provided with connectors at its ends. Connecting these connectors to connectors provided on the circuit boards 84 and 86 establishes connection between the circuit boards 84 and 86 through the wiring harness 85.

When the projection lens 83 is to be interchanged, the connector of the wiring harness 85 (hereinafter referred to as the “lens connector”) is first disconnected from the main circuit board 86, and then the projection lens 83 is detached from the main body 82. Detaching the projection lens 83 from the main body 82 opens a projection opening (that is, a through-hole through which the projection lens 83 projects light onto a projection surface) 87, which exposes a light exit surface of a third polarization beam splitter 205c through the projection opening 87.

Therefore, in this embodiment, a controller 511 provided on the main circuit board 86 causes a shutter unit 70 to shut in response to disconnection of the lens connector, that is, when the projector enters into the state allowing the projection lens 83 to be interchanged. This enables the shutter unit 70 to cover the light exit surface of the third polarization beam splitter 205c facing the projection opening 87. Therefore, it is possible to prevent the projection lens 83 or a newly attached projection lens from making contact to the light exit surface of the third polarization beam splitter 205c and to prevent dust entering into the main body 82 through the projection opening 87 from attaching to the light exit surface. Thus, protection of the color separation/combination optical unit 200 can be made.

The state allowing the projection lens to be interchanged includes not only the above-described state where the lens connector is disconnected, but also a state where power of the projector is turned off and a state where an operation for removing the projection lens other than the operation for disconnecting the lens connector is performed.

FIG. 7 shows a flowchart of an operation example of the projector (controller 511) for interchanging the projection lens 83. The controller 511 executes this operation according to a computer program. Description herein will be made of an operation example for a case where the projection lens 83 is interchanged during lighting of the light source lamp.

The controller 511 having detected at step S1 that the lens connector has been disconnected from the main circuit board 86 by a user changes at step S2 an operation state of liquid crystal panels 206R, 206G and 206B from a normal image display state to an entire black display state where an entire black image is displayed. This is because of preventing light exiting through the projection opening (through-hole) 87 from providing glare to the user after the projection lens 83 is detached.

Next, the controller 511 at step S3 rotates a motor 81 shown in FIG. 4 to cause the shutter unit 70 to shut. The user attaches a new projection lens to the main body 82 and connects a lens connector extending from the newly attached projection lens to the main circuit board 86.

The controller 511 having detected at step S4 the connection of the lens connector to the main circuit board 86 rotates the motor 81 at step S5 to cause the shutter unit 70 to open. Then, at step S6 the controller 511 changes the operation state of the liquid crystal panels 206R, 206G and 206B from the entire black display state to the original normal display state.

### Embodiment 3

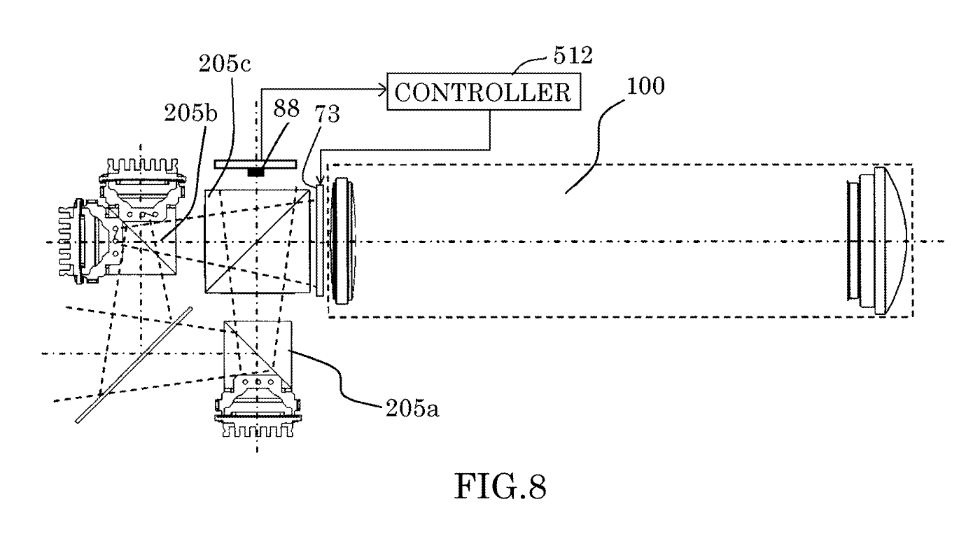

There is a case where a projector requires adjustment of a driving voltage of each of liquid crystal panels. FIG. 8 shows a configuration of a projector that is a third embodiment (Embodiment 3) of the present invention. This projector is provided with a photodetector 88 being used to adjust a driving voltage of each of liquid crystal panels 206R, 206G and 206B.

The photodetector 88 detects unnecessary light (leakage light) exiting outside an effective optical path. Referencing an amount of flicker included in the unnecessary light enables adjustment of the driving voltage of each liquid crystal panel. This embodiment detects the leakage light from a third polarization beam splitter 205c by using the photodetector 88, and causes a controller 512 to adjust the driving voltage of each liquid crystal panel. At this time, the controller 512 shuts a shutter unit 70.

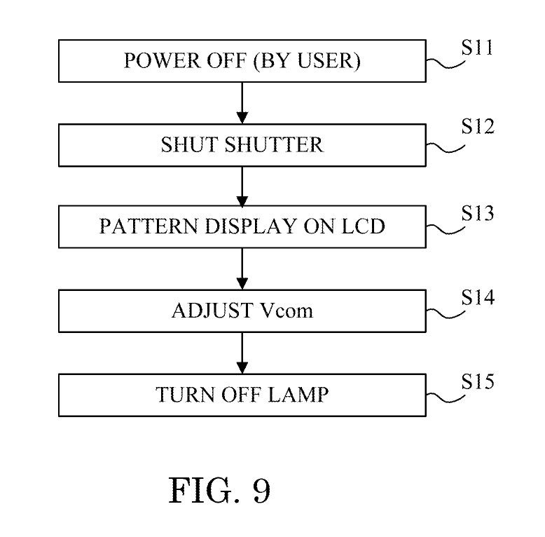

FIG. 9 shows a flowchart of an operation example of the projector (controller 512) when adjusting the driving voltage of each of the liquid crystal panels 206R, 206G and 206B. The controller 512 performs this operation according to a computer program. Description herein will be made of a case (power-off sequence) where the controller 512 enters a mode allowing adjustment of the driving voltage of each liquid crystal panel in response to power-off of the projector. However, the controller 512 may enter into such a mode allowing the adjustment of the driving voltage regardless of the power-off of the projector.

The controller 512 having detected at step S11 the power-off of the projector by the user causes the shutter unit 70 to shut at step S12.

Next, the controller 512 at step S13 causes the liquid crystal panels 206R, 206G and 206B to display original images including a predetermined pattern. At this time, since the shutter unit 70 is in the shut state, it is possible to prevent an image corresponding to the predetermined pattern, that is, a strange image for the user or a viewer from being projected onto a projection surface.

Next, the controller 512 at step S14 adjusts the driving voltage (Vcom) of each liquid crystal panel with reference to the amount of the flicker obtained from the output from photodetector 88. After completion of the adjustment, the controller 512 turns off the light source lamp at step S15 to end the power-off sequence.

Although the description in each of Embodiments 1 to 3 was made of the case where the reflective liquid crystal panels are used as the light modulating elements, other light modulating elements such as digital micromirror devices (DMDs) and transmissive liquid crystal panels may be used as the light modulating elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-247236, filed on Oct. 28, 2009, which is hereby incorporated by reference herein in its entirety.

What is claimed is:

1. An image projection apparatus comprising:
a light modulating element;
a projection lens configured to project light modulated by the light modulating element onto a projection surface;
an optical unit configured to introduce light from a light source to the light modulating element, and to introduce the light from the light modulating element to the projection lens;
a shutter unit disposed between the optical unit and the projection lens, and configured to be capable of shutting to block the light from the optical unit from entering the projection lens; and
a controller configured to set an operation state of the light modulating element such that, in a state where the shutter unit is shut, an intensity of the light reaching the shutter unit from the optical unit becomes smaller than that in an entire white display state.

2. An image projection apparatus according to claim 1,
wherein the projection lens is interchangeable with respect to the optical unit, and
wherein the controller is configured to shut the shutter unit in response to detection that the apparatus is in a state allowing interchanging of the projection lens.

3. An image projection apparatus according to claim 1, wherein the controller is configured to shut the shutter unit when the apparatus is in a mode allowing adjustment of a driving voltage of the light modulating element.
